(19) United States
(12) Patent Application Publication
(10) Pub. No.: US 2004/0075860 A1
(43) Pub. Date: Apr. 22, 2004

(54) Printer, print system, and print client, and data receiving device, data transmitting and receiving system, and data transmitting device

(76) Inventors: Toshihiro Shima, Nagano-ken (JP); Kazuhito Gassho, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/464,070

(22) Filed: Jun. 17, 2003

(30) Foreign Application Priority Data
Jun. 17, 2002 (JP) 2002-176241

(51) Int. Cl. G06F 3/12; G06F 15/00

(52) U.S. Cl. 358/1.15; 358/1.5

(57) ABSTRACT

A printer calculates a distance between a print client which makes a print request and a printer based on print client position information and printer position information. When the distance between them is within a predetermined range, the print request from the print client is accepted, and when the distance between them is not within the predetermined range, the print request from the print client is not accepted. For example, when the print request is not accepted, the printer does not permit the print client to transmit print data to the printer. Consequently, the print request accepted by the printer is restricted by the distance between the print client and the printer.

### BACKGROUND OF THE INVENTION

1. Field of the Invention

The present invention relates to a printer, a print system, and a print client, and a data receiving device, a data transmitting and receiving system, and a data transmitting device.

2. Description of the Related Art

These days, a print system in which a printer is shared by means of a network such as the Internet has been increasingly used. Namely, by connecting plural computers as print clients to one network and connecting, for example, one printer to this network, one printer can accept print data from the plural print clients and execute a print operation.

Moreover, a service, in which one printer is installed in a store such as an Internet cafe and customers who come to the store can perform printing by this printer, is provided. In this case, the printer installed in the store is connected to the Internet, and the customer connects a computer which is the print client to the Internet and transmits print data to the printer in this store, whereby a print operation is executed.

However, if the printer prints the print data transmitted from the print client unconditionally, a print operation is executed even when the print data is transmitted by mistake to a printer installed in a distant place, which a user does not intend to use. In this case, since the user does not know the location where the printer is installed, it is virtually impossible to collect printed matters.

Further, when a customer of the Internet cafe acquires an IP address of the printer in the store, the customer can transmit print data to the printer in the store from his or her home even after he or she comes home. However, from the nature of Internet cafe business, there is a demand that users capable of making print requests to the printer installed in the store be limited to customers who actually come to the store.

Hence, the present invention is made in view of the aforementioned problem, and an object of the present invention is to provide a print system capable of making a print request to a printer only when the relative distance between a print client and the printer is within a predetermined range. Another object of the present invention is to provide a data transmitting and receiving system capable of making a predetermined process request to a data receiving device only when the relative distance between a data transmitting device and the data receiving device is within a predetermined range.

### SUMMARY OF THE INVENTION

In order to accomplish the aforementioned and other objects, according to one aspect of the present invention, a printer connected to a print client via a network, comprises:

a print client position information acquisition which acquires print client position information indicating a position where the print client is installed;

a printer position information acquisition which acquires printer position information indicating a position where the printer is installed;

a first judgment section which judges whether a distance between the print client and the printer is within a predetermined range based on the print client position information and the printer position information; and

a second judgment section which accepts a print request from the print client when the first judgment section judges that the distance between the print client and the printer is within the predetermined range and restricts the print request from the print client when the first judgment section judges that the distance between the print client and the printer is not within the predetermined range.

According to another aspect of the present invention, a print system includes a printer and a print client connected to the printer via a network,

wherein the print client comprises a first print client position information acquisition which acquires print client position information indicating a position where the print client is installed, and

wherein the printer comprises:

a second print client position information acquisition which acquires the print client position information from the print client;

a printer position information acquisition which acquires printer position information indicating a position where the printer is installed;

a first judgment section which judges whether a distance between the print client and the printer is within a predetermined range based on the print client position information and the printer position information; and

a second judgment section which accepts a print request from the print client when the first judgment section judges that the distance between the print client and the printer is within the predetermined range and restricts the print request from the print client when the first judgment section judges that the distance between the print client and the printer is not within the predetermined range.

According to another aspect of the present invention, a method of controlling a printer connected to a print client via a network, comprises the steps of:

acquiring print client position information indicating a position where the print client is installed;

acquiring printer position information indicating a position where the printer is installed;

judging whether a distance between the print client and the printer is within a predetermined range based on the print client position information and the printer position information;

accepting a print request from the print client when it is judged that the distance between the print client and the printer is within the predetermined range; and

restricting the print request from the print client when it is judged that the distance between the print client and the printer is not within the predetermined range.

According to another aspect of the present invention, a method of controlling a print system including a printer and a print client connected to the printer via a network, comprises the steps of:

acquiring print client position information indicating a position where the print client is installed in the print client;

transmitting the print client position information from the print client to the printer;

acquiring the print client position information transmitted from the print client in the printer;

acquiring printer position information indicating a position where the printer is installed in the printer;

judging whether a distance between the print client and the printer is within a predetermined range based on the print client position information and the printer position information;

accepting a print request from the print client when it is judged that the distance between the print client and the printer is within the predetermined range, and

restricting the print request from the print client when it is judged that the distance between the print client and the printer is not within the predetermined range.

According to another aspect of the present invention, a print client connected to a printer via a network, comprises:

a print client position information acquisition which acquires print client position information indicating a position where the print client is installed;

a print client position information transmitter which transmits the print client position information acquired by the print client position information acquisition to the printer;

a judgment result receiver which receives a judgment result from the printer, as to whether the printer gives a print permission based on the print client position information; and

a print data transmitter which transmits print data to the printer when the judgment result received by the judgment result receiver indicates that the printer gives the print permission and does not transmit the print data to the printer when the judgment result indicates that the printer does not give the print permission.

According to another aspect of the present invention, a print client connected to a printer via a network, comprises:

a print client position information acquisition which acquires print client position information indicating a position where the print client is installed;

a print transmitting data generator which generates print transmitting data by incorporating the print client position information acquired by the print client position information acquisition into print data; and

a print data transmitter which transmits the print transmitting data generated by the print transmitting data generator to the printer.

According to another aspect of the present invention, a method of controlling a print client connected to a printer via a network, comprises the steps of:

acquiring print client position information indicating a position where the print client is installed;

transmitting the acquired print client position information to the printer;

receiving a judgment result from the printer, as to whether the printer gives a print permission based on the print client position information; and

transmitting print data to the printer when the received judgment result indicates that the printer gives the print permission and not transmitting the print data to the printer when the judgment result indicates that the printer does not give the print permission.

According to another aspect of the present invention, a method of controlling a print client connected to a printer via a network, comprises the steps of:

acquiring print client position information indicating a position where the print client is installed;

generating print transmitting data by incorporating the acquired print client position information into print data; and

transmitting the generated print transmitting data to the printer.

According to another aspect of the present invention, a data receiving device connected to a data transmitting device via a network, comprises:

a data transmitting device position information acquisition which acquires data transmitting device position information indicating a position where the data transmitting device is installed;

a data receiving device position information acquisition which acquires data receiving device position information indicating a position where the data receiving device is installed;

a first judgment section which judges whether a distance between the data transmitting device and the data receiving device is within a predetermined range based on the data transmitting device position information and the data receiving device position information; and

a second judgment section which accepts a process request from the data transmitting device when the first judgment section judges that the distance between the data transmitting device ad the data receiving device is within the predetermined range and restricts the process request from the data transmitting device when the first judgment section judges that the distance between the data transmitting device and the data receiving device is not within the predetermined range.

According to another aspect of the present invention, a data transmitting and receiving system includes a data receiving device and a data transmitting device connected to the data receiving device via a network,

wherein the data transmitting device comprises a first data transmitting device position information acquisition which acquires data transmitting device position information indicating a position where the data transmitting device is installed, and

wherein the data receiving device comprises:

a second data transmitting device position information acquisition which acquires the data transmitting device position information from the data transmitting device;

a data receiving device position information acquisition which acquires data receiving device position information indicating a position where the data receiving device is installed;

a first judgment section which judges whether a distance between the data transmitting device and the data receiving device is within a predetermined range based on the data transmitting device position information and the data receiving device position information; and

a second judgment section which accepts a process request from the data transmitting device when the first judgment section judges that the distance between the data transmitting device and the data receiving device is within the predetermined range and restricts the process request from the data transmitting device when the first judgment section judges that the distance between the data transmitting device and the data receiving device is not within the predetermined range.

According to another aspect of the present invention, a data transmitting device connected to a data receiving device via a network, comprises:

a data transmitting device position information acquisition which acquires data transmitting device position information indicating a position where the data transmitting device is installed;

a data transmitting device position information transmitter which transmits the data transmitting device position information acquired by the data transmitting device position information acquisition to the data receiving device;

a judgment result receiver which receives a judgment result, as to whether the data receiving device gives a process permission based on the data transmitting device position information, from the data receiving device;

a process data transmitter which transmits process data to the data receiving device when the judgment result received by the judgment result receiver indicates that the data receiving device gives the process permission and does not transmit the process data to the data receiving device when the judgment result indicates that the data receiving device does not give the process permission.

According to another aspect of the present invention, a data transmitting device connected to a data receiving device via a network, comprises:

a data transmitting device position information acquisition which acquires data transmitting device position information indicating a position where the data transmitting device is installed;

a transmitting process data generator which generates transmitting process data by incorporating the data transmitting device position information acquired by the data transmitting device position information acquisition into process data; and

a process data transmitter which transmits the transmitting process data generated by the transmitting process data generator to the data receiving device.

According to another aspect of the present invention, a method of controlling a data receiving device connected to a data transmitting device via a network, comprises the steps of:

acquiring data transmitting device position information indicating a position where the data transmitting device is installed;

acquiring data receiving device position information indicating a position where the data receiving device is installed;

judging whether a distance between the data transmitting device and the data receiving device is within a predetermined range based on the data transmitting device position information and the data receiving device position information;

accepting a process request from the data transmitting device when it is judged that the distance between the data transmitting device and the data receiving device is within the predetermined range; and

restricting the process request from the data transmitting device when it is judged that the distance between the data transmitting device and the data receiving device is not within the predetermined range.

According to another aspect of the present invention, a method of controlling a data transmitting and receiving system including a data receiving device and a data transmitting device connected to the data receiving device via a network, comprises the steps of:

acquiring data transmitting device position information indicating a position where the data transmitting device is installed in the data transmitting device;

acquiring the data transmitting device position information from the data transmitting device in the data receiving device;

acquiring data receiving device position information indicating a position where the data receiving device is installed;

judging whether a distance between the data transmitting device and the data receiving device is within a predetermined range based on the data transmitting device position information and the data receiving device position information;

accepting a process request from the data transmitting device when it is judged that the distance between the data transmitting device and the data receiving device is within the predetermined range, and

restricting the process request from the data transmitting device when it is judged that the distance between the data transmitting device and the data receiving device is not within the predetermined range.

According to another aspect of the present invention, a method of controlling a data transmitting device connected to a data receiving device via a network, comprises the steps of:

acquiring data transmitting device position information indicating a position where the data transmitting device is installed;

transmitting the acquired data transmitting device position information to the data receiving device;

receiving a judgment result, as to whether the data receiving device gives a process permission based on the data transmitting device position information, from the data receiving device;

transmitting process data to the data receiving device when the received judgment result indicates that the data receiving device gives the process permission; and

canceling the transmission of the process data to the data receiving device when the judgment result indicates that the data receiving device does not give the process permission.

According to another aspect of the present invention, a method of controlling a data transmitting device connected to a data receiving device via a network, comprises the steps of:

acquiring data transmitting device position information indicating a position where the data transmitting device is installed;

generating transmitting process data by incorporating the acquired data transmitting device position information into process data; and

transmitting the generated transmitting process data to the data receiving device.

### BRIEF DESCRIPTION OF THE DRAWINGS

FIG. 1 is a diagram showing an example of the configuration of a print system according to each of embodiments of the present invention;

FIG. 2A is a diagram showing an example of the hardware configuration of a printer according to each of the embodiments of the present invention;

FIG. 2B is a diagram showing a modification of the hardware configuration of the printer;

FIG. 3A is diagram showing an example of the hardware configuration of a print client according to each of the embodiments of the present invention;

FIG. 3B is a diagram showing a modification of the hardware configuration of the print client;

FIG. 4 is a flowchart explaining a print request process executed by a print client according to a first embodiment of the present invention;

FIG. 5 is a flowchart explaining a print request acceptance process executed by a printer according to the first embodiment of the present invention;

FIG. 6 is a flowchart explaining a print request process executed by a print client according to a second embodiment of the present invention;

FIG. 7 is a diagram showing an example of the configuration of print transmitting data which is transmitted from the print client to a printer according to the second embodiment of the present invention; and

FIG. 8 is a flowchart explaining a print request acceptance process executed by the printer according to the second embodiment of the present invention.

### DETAILED DESCRIPTION OF THE EMBODIMENTS

[First Embodiment]

A print system according to the first embodiment of the present invention is designed in such a manner that a printer permits a print client to transmit print data only when a distance between the print client and the printer is within a predetermined range, and thereby the printer accepts print requests from limited print clients within the predetermined range. Further details will be given below.

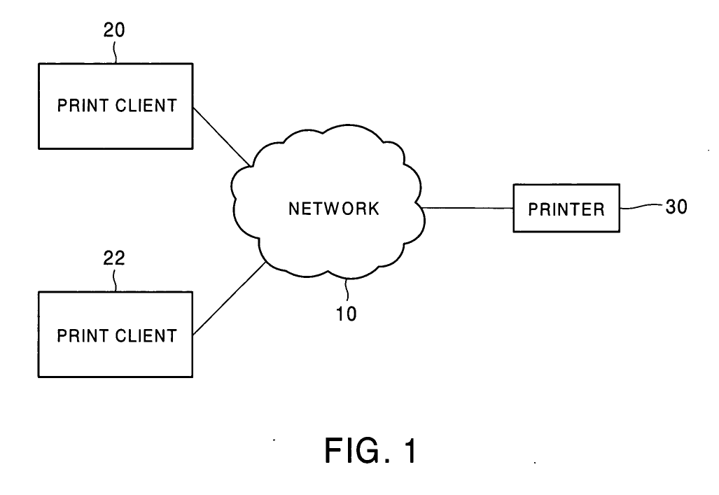

First, the configuration of the print system according to this embodiment will be explained based on FIG. 1. FIG. 1 is a block diagram showing the hardware configuration of the print system according to this embodiment.

As shown in FIG. 1, the print system according to this embodiment includes print clients 20 and 22 connected to a network 10 and a printer 30 also connected to the network 10. In this embodiment, the network 10 is constituted by the Internet using TCP/IP (transmission control protocol/internet protocol). However, the form of the network 10 is not limited to the Internet, and, for example, it may be constituted by a LAN such as Ethernet (registered trademark) or by mixing the Internet and the LAN. Moreover, the network 10 may be wireless, or may be wireless and wired in a mixed manner.

The print clients 20 and 22 are each composed of any of various kinds of computers, for example, called a host computer and a personal computer. In this embodiment, in particular, the print clients 20 and 22 generate print data and transmit the print data to the printer 30 via the network 10. The print clients 20 and 22 have their own peculiar network addresses, respectively. The number of print clients connected to the network 10 is optional, and it may be one or more than one. Moreover, the print client is not limited to a computer, and, for example, it may be a digital camera with a necessity to print a taken image, a content server in which print image data is stored as contents or the like.

Further, in this embodiment, the printer 30 is a so-called network printer. In this embodiment, particularly before accepting print data from the print client 20 or 22, the printer 30 acquires print client position information on the print client 20 or 22 and printer position information on the printer 30, and accepts the print data from the print client 20 or 22 only when the distance between the print client 20 or 22 and the printer 30 is within a predetermined range.

In this embodiment, the printer 30 is directly connected to the network 10 and each printer 30 has its own peculiar network address. Accordingly, in terms of the network, the print clients 20 and 22 can transmit print data to the printer 30 by designating its network address.

Furthermore, in this embodiment, the print clients 20 and 22 and the printer 30 are installed in one store or on the premises of one company. Namely, it is assumed that the distance between each of the print clients 20 and 22 and the printer 30 is within a predetermined range. The distance is, however, optional.

Incidentally, although the printer 30 is directly connected to the network 10 in FIG. 1, it may be connected thereto via a printer server. Moreover, the number of printers connected to the network 10 is optional, and it may be one or more than one.

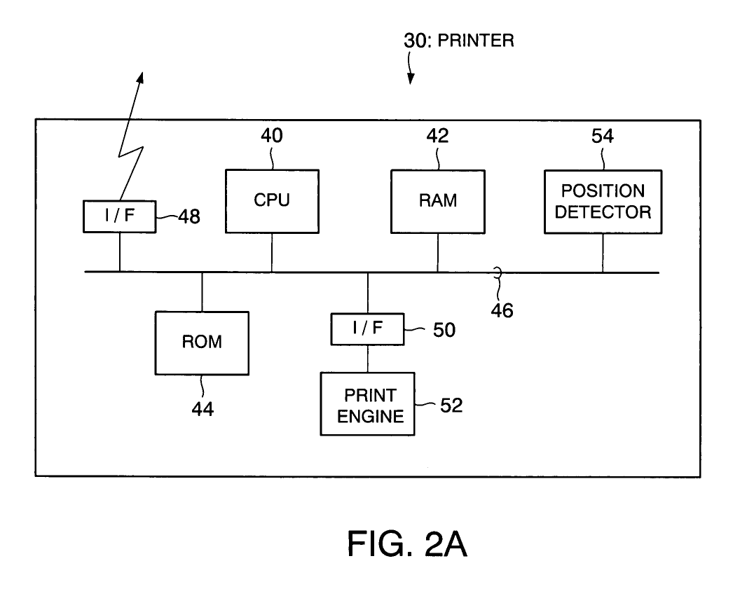

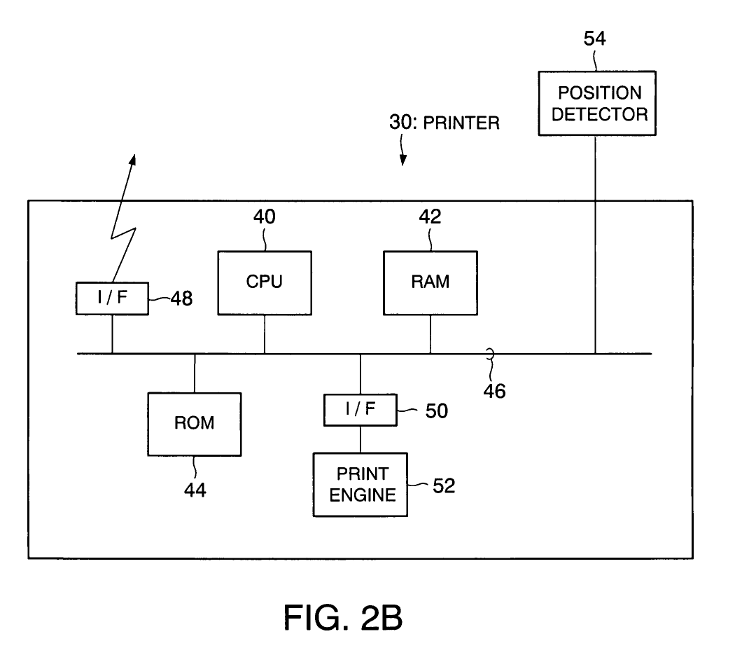

FIG. 2A is a block diagram explaining the internal configuration of the printer 30. As shown in FIG. 2A, the printer 30 includes a CPU (Central Processing Unit) 40, a RAM (Random Access Memory) 42, and a ROM (Read Only Memory) 44, and they are connected to each other via an internal bus 46. A communication interface 48 is connected to the internal bus 46, and the printer 30 is connected to the aforementioned network 10 via the communication interface 48. In addition, an interface 50 is connected to the internal bus 46, and a print engine 52 is connected to the interface 50.

Moreover, a position detector 54 is connected to the internal bus 46. This position detector 54 has a function of specifying a position where the printer 30 is installed. In this embodiment, it is constituted, for example, by a GPS (global positioning system), and the latitude, longitude, and altitude of the position where the printer 30 is installed can be specified. It is said that the accuracy of the GPS at the present time is approximately ±10 m in the latitude, the longitude, and the altitude, respectively.

However, the constitution of the position detector 54 is not limited to the constitution using the GPS, and, for example, when the printer 30 is connected to the network 10 by a wireless LAN, the position of the printer 30 may be specified based on a wireless base station which accommodates the printer 30. Alternatively, the position of the printer 30 may be specified by using mobile communication technology including the PHS (Personal Handyphone System).

Further, it is also possible that the position detector 54 includes both a GPS function and a PHS function and normally detects an installation position by the GPS, but when it cannot detect the position by the GPS due to radio wave conditions, it may detect the position by the PHS.

Furthermore, although the position detector 54 is contained in the printer 30 in FIG. 2A, the position detector 54 may be provided outside the printer 30 as shown in FIG. 2B. For example, it is possible that when the necessity arises, a cellular phone equipped with the GPS is connected to the printer 30, and thereby the printer 30 has a position detection function.

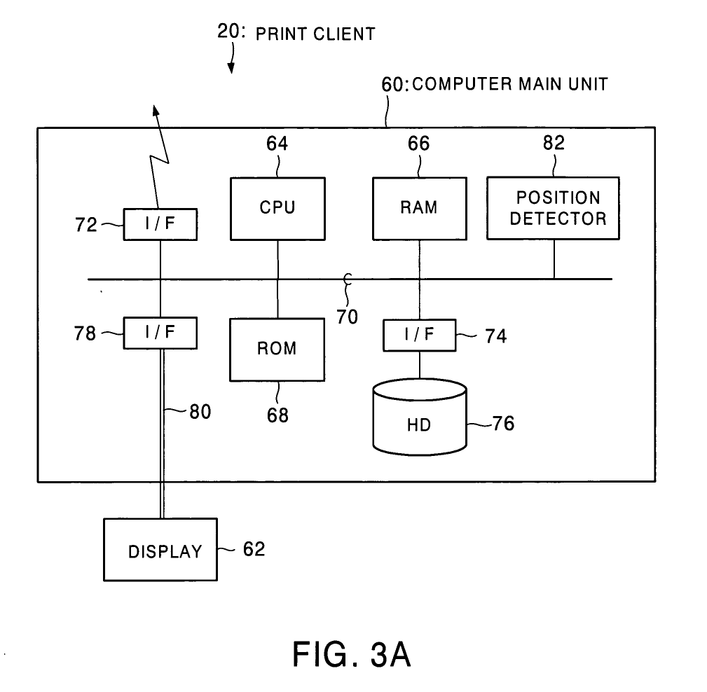

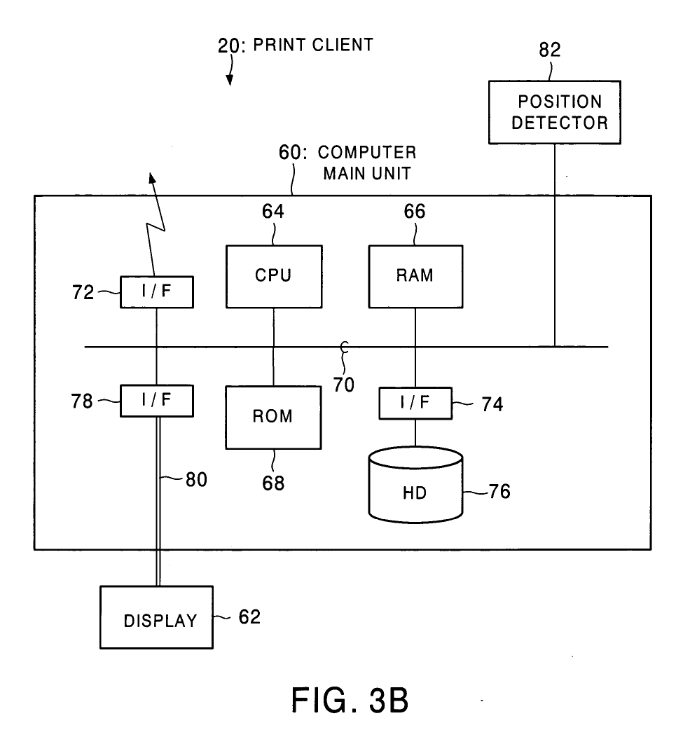

FIG. 3A is a block diagram explaining the internal configuration of the print client 20. It should be mentioned that the internal configuration of the print client 22 is the same as that of the print client 20 in this embodiment.

As shown in FIG. 3A, the print client 20 according to this embodiment includes a computer main unit 60 and a display 62.

The computer main unit 60 includes a CPU 64, a RAM 66, and a ROM 68, and they are connected to each other via an internal bus 70. A communication interface 72 is connected to the internal bus 72, and the print client 20 is connected to the aforementioned network 10 via the communication interface 72.

In addition, an interface 74 is connected to the internal bus 70, and a hard disk 76 which is a large capacity storage is connected to the interface 74. Additionally, an interface 78 is connected to the internal bus 70, and the aforementioned display 62 is connected via a cable 80 which extends from the interface 78.

Moreover, a position detector 82 is connected to the internal bus 70. This position detector 82 has a function of specifying a position where the print client 20 is installed. Similarly to the aforementioned printer 30, the position detector 82 is constituted by the GPS, and the latitude, longitude, and altitude of the position where the print client 20 is installed can be specified. However, also in this case, the constitution of the position detector 82 is not limited to the constitution using the GPS, and when the print client 20 is connected to the network 10 by the wireless LAN, the position of the print client 20 may be specified based on a wireless base station which accommodates the print client 20. Alternatively, the position of the print client 20 maybe specified by using mobile communication technology including the PHS (Personal Handyphone System).

Further, it is also possible that the position detector 82 includes both a GPS function and a PHS function and normally detects an installation position by the GPS, but when it cannot detect the position by the GPS due to radio wave conditions, it may detect the position by the PHS.

Furthermore, although the position detector 82 is contained in the computer main unit 60 in FIG. 3A, the position detector 82 may be provided outside the computer main unit 60 as shown in FIG. 3B. For example, it is possible that when the necessity arises, the cellular phone equipped with the GPS is connected to the computer main unit 60, and thereby the print client 20 has a position detection function.

Next, a process executed by the print clients 20 and 22 and the printer 30 when users of the print clients 20 and 22 make print requests to the printer 30 will be explained in detail. First, a process on the print clients 20 and 22 side will be explained.

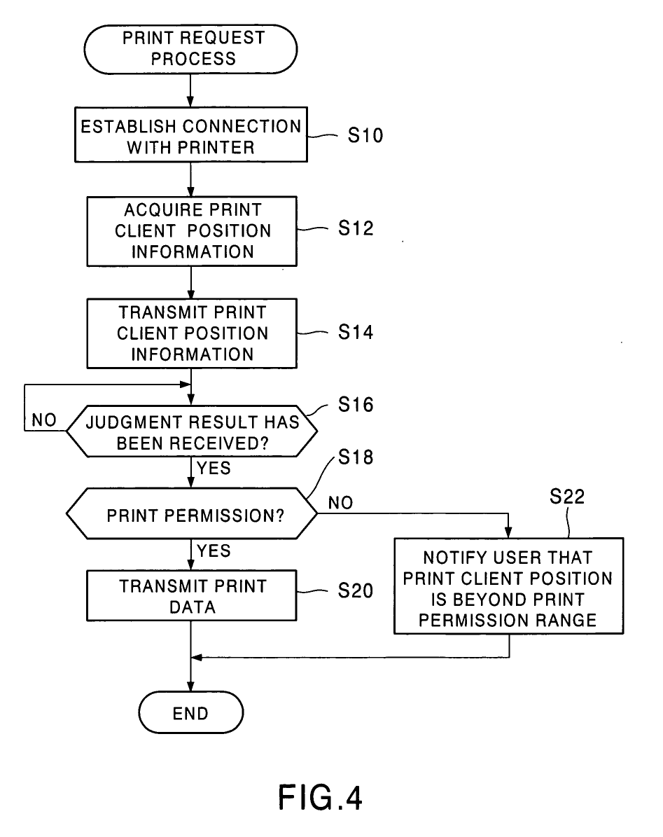

FIG. 4 is a flowchart explaining a print request process executed by the print clients 20 and 22. This print request process is realized by making the CPU 64 read and execute a print request program stored in the ROM 68 or the hard disk 76 of each of the print clients 20 and 22. Here, assuming a case where the print client 20 makes a print request to the printer 30, the following explanation is given.

As shown in FIG. 4, in this print request process, first, the print client 20 establishes a connection with the printer 30 (step S10). In this embodiment, the print client 20 ensures secrecy by SSL (secure socket layer) communication and establishes a connection with the printer 30.

Thereafter, the print client 20 acquires print client position information (step S12). Specifically, it acquires the latitude, longitude, and altitude of the position where the print client 20 is installed at this point in time from the position detector 82. Namely, the print client 20 acquires the absolute position of the print client 20 as the print client position information.

Then, the print client 20 transmits this print client position information to the printer 30 (step S14). Specifically, it designates the network address of the printer 30 and sends out the print client position information to the network 10. Subsequently, the print client 20 judges whether a judgment result indicating print permission or print refusal has been received from the printer 30 (step S16). When the judgment result has not been received (step S16: No), the print client 20 stands by while repeating the process in step S16.

When the judgment result has been received from the printer 30 (step S16: Yes), whether the judgment result indicates print permission is judged (step S18). When the judgment result indicates print permission (step S18: Yes), the print client 20 generates print data and transmits it to the printer 30 (step S20). Specifically, it designates the network address of the printer 30 and sends out the print data to the network 10. Incidentally, although the print data is encrypted and transmitted to the printer 30 at the time of transmission in this embodiment, the print data need not be necessarily encrypted.

On the other hand, when it is judged in step S18 that the judgment result does not indicate print permission (step S18: No), that is, when the judgment result indicates print refusal, the print client 20 notifies its user that a print request is not accepted by the printer 30 since the position where the print client 20 is installed is beyond a print permission range of the printer 30 (step S22).

The print request process according to this embodiment is completed by the above step S20 or step S22.

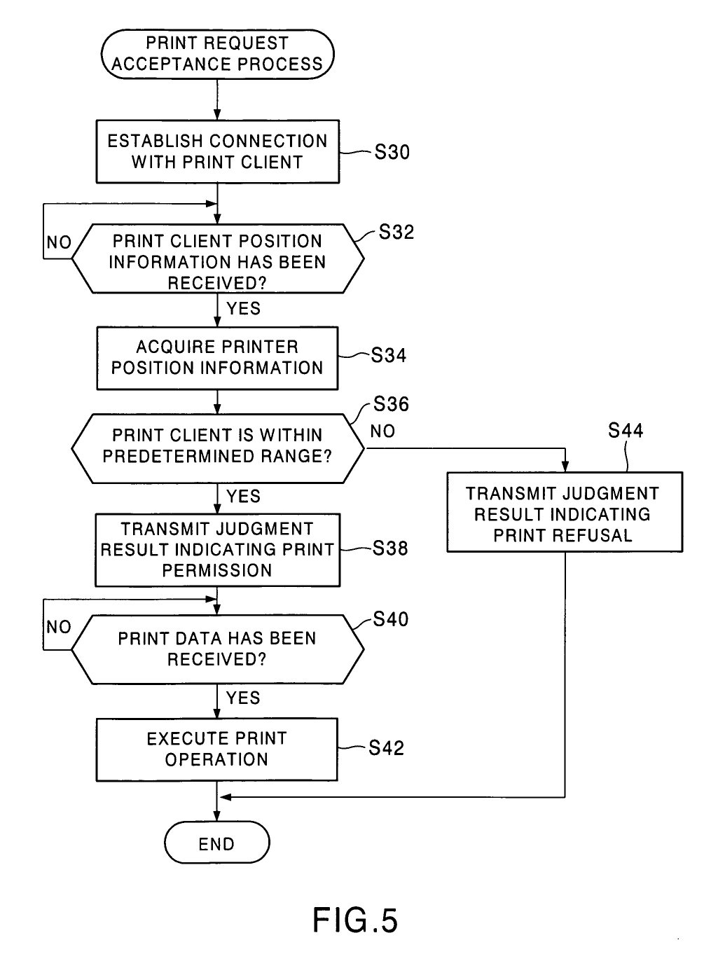

Next, a print request acceptance process executed by the printer 30 corresponding to the print request process will be explained based on FIG. 5. FIG. 5 is a flowchart explaining the print request acceptance process executed by the printer 30. This print request acceptance process is realized by making the CPU 40 read and execute a print request acceptance program stored in the ROM 44 of the printer 30. Also here, similarly to the above, assuming the case where the print client 20 makes a print request to the printer 30, the following explanation is given.

As shown in FIG. 5, first, the printer 30 establishes a connection with the print client 20 (step S30). This corresponds to the aforementioned step S10 on the print client 20 side. Namely, the print client 20 and the printer 30 are connected by SSL communication which ensures secrecy.

Thereafter, the printer 30 judges whether the print client position information has been received from the print client 20 (step S32). When the print client position information has not been received (step S32: No), the printer 30 stands by while repeating the process in step S32.

On the other hand, when the print client position information has been received (step S32: Yes), the printer 30 acquires printer position information (step S34). Specifically, it acquires the latitude, longitude, and altitude of the position where the printer 30 is installed at this point in time from the position detector 54. Namely, the printer 30 acquires the absolute position of the printer 30 as the printer position information.

Then, the printer 30 judges whether the print client 20 is located within a predetermined range relative to the printer 30 (step S36). Namely, the relative distance between the print client 20 and the printer 30 is calculated based on the print client position information and the printer position information, and whether the calculated distance is not more than a predetermined value is judged. In this embodiment, when the latitude, longitude, and altitude of the print client position information are taken as X1, Y1, and Z1 respectively, the latitude, longitude, and altitude of the printer position information are taken as X2, Y2, and Z2 respectively, and the distances of the predetermined range are taken as Lx, Ly, and Lz respectively, whether the relative distances in the latitude, longitude, and altitude are not more than Lx, Ly, or Lz respectively is judged. Namely if |X1−X2|≦Lx, |Y1−Y2|≦Ly, and |Z1−Z2|≦Lz, the printer 30 judges that the print client 20 is located within the predetermined range.

In this case, Lx, Ly, and Lz need not be necessarily the same distance. For example, if the setting of Lx=20 m, Ly=20 m, and Lz=5 m is made, only print requests from print clients which are located on the same floor in a high-rise building can be permitted.

Moreover, the range in which print requests are permitted can be set asymmetrically in respective positive and negative directions of an X-axis direction, a Y-axis direction, and a Z axis direction. Namely, only when the condition of −10 m≦X1−X2≦5 m, −15 m≦Y1−Y2≦10 m, and −5 m≦Z1−Z2≦3 m is satisfied, print requests from the corresponding clients may be permitted.

Further, concerning the predetermined range in which print requests are permitted, a distance L is calculated by the following equation (1), and if this distance L is not more than the predetermined value, the print client 20 may be judged to be within the predetermined range.

L=√{(X1−X2)²+(Y1−Y2)²+(Z1−Z2)²} (1)

When the print client 20 is located within the predetermined range (step S36: Yes), the printer 30 transmits a judgment result indicating print permission to the print client 20 (step S38). Specifically, it designates the network address of the print client 20 and sends out the judgment result indicating print permission to the network 10. Subsequently, the printer 30 judges whether the print data has been received from the print client 20 (step S40). When the print data has not been received (step S40: No), the printer 30 stands by while repeating the process in step S40.

On the other hand, when the print data has been received (step S40: Yes), the printer 30 executes a print operation based on the received print data (step S42). Specifically, the encrypted print data is decrypted, a language interpretation of the decrypted print data is performed, and print request data fitting the print engine 52 is generated. Then, by transmitting this print request data to the print engine 52, print sheets and so on are printed by the print engine 52.

Contrary to this, when it is judged in the aforementioned step S36 that the print client 20 is not located within the predetermined range (step S36: No), the printer 30 transmits a judgment result indicating print refusal to the print client 20 (step S44). Specifically, it designates the network address of the print client 20 and sends out the judgment result indicating print refusal to the network 10.

The print request acceptance process is completed by the above step S42 or step S44.

As described above, according to the print system of this embodiment, the printer 30 accepts print requests from print clients located within a predetermined distance range relative to the printer 30, but the printer 30 does not accept any print request from print clients which are not located within the predetermined distance range. Hence, the installation range of print clients from which the printer 30 accepts print requests can be restricted.

For example, when the printer 30 is installed in an Internet cafe, print requests to the printer 30 from outside the Internet cafe can be rejected by setting the predetermined range within the Internet cafe.

Moreover, when the printer 30 is installed in an institute or the like of some company, print requests to the printer 30 from outside the premises of this company can be rejected by setting the predetermined range within the premises of the institute.

Further, according to the print system of this embodiment, when a print client user tries to make a print request to the printer 30 installed in a distant place, which the user does not intend to use, the user cannot obtain the judgment result indicating print permission from the printer 30, so that the user cannot make the print request. Hence, the execution of a print operation by the printer 30 installed in the distant place, which the user does not intend to use, can be avoided.

[Second Embodiment]

In the second embodiment of the present invention, when a print client transmits print data to a printer, the print client also transmits print client position information in addition to the print data to the printer. The printer receives the print client position information and judges whether the print client is within a predetermined range relative to the printer based on the print client position information, and when it is within the predetermined range, the printer executes a print operation based on the print data. Further details will be given below.

It should be noted that the hardware configuration of a print system according to this embodiment is the same as that in FIG. 1 in the aforementioned first embodiment, the hardware configuration of the printer 30 is the same as that in FIG. 2A or FIG. 2B described above, and the hardware configuration of each of the print clients 20 and 22 is the same as that in FIG. 3A or FIG. 3B described above.

A process executed by the print clients 20 and 22 and the printer 30 when users of the print clients 20 and 22 make print requests to the printer 30 will be explained in detail. First, a process on the print clients 20 and 22 side will be explained.

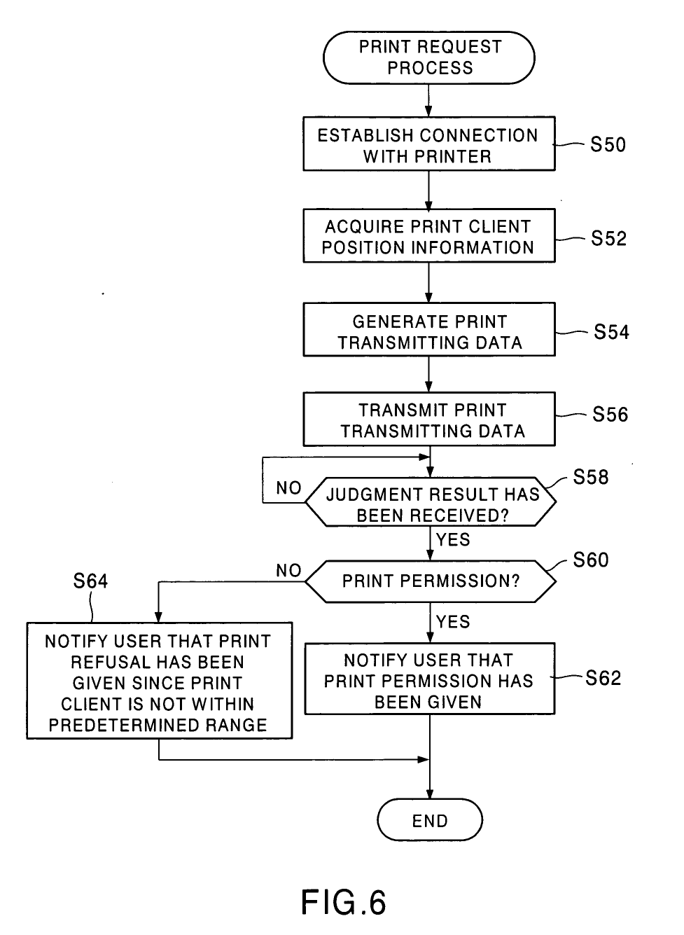

FIG. 6 is a flowchart explaining a print request process executed by the print clients 20 and 22. This print request process is realized by making the CPU 64 read and execute a print request program stored in the ROM 68 or the hard disk 76 of each of the print clients 20 and 22. Here, assuming a case where the print client 20 makes a print request to the printer 30, the following explanation is given.

As shown in FIG. 6, in this print request process, first, the print client 20 establishes a connection with the printer 30 (step S50). In this embodiment, similarly to the aforementioned first embodiment, the print client 20 ensures secrecy by SSL (secure socket layer) communication and establishes a connection with the printer 30.

Thereafter, the print client 20 acquires print client position information (step S52). Specifically, it acquires the latitude, longitude, and altitude of the position where the print client 20 is installed at this point in time from the position detector 82. Namely, the print client 20 acquires the absolute position of the print client 20 as the print client position information.

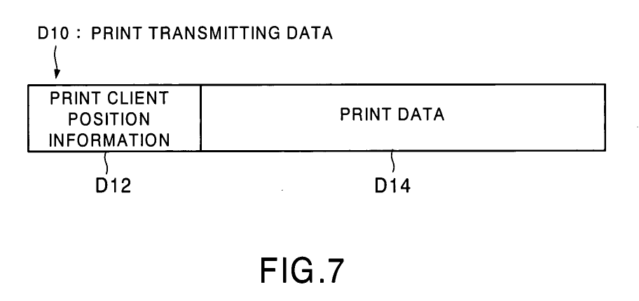

Subsequently, the print client 20 generates print data, and generates print transmitting data by adding the print client position information to the print data (step S54). FIG. 7 is a diagram showing an example of a format of print transmitting data D10 according to this embodiment. As shown in FIG. 7, the print transmitting data D10 is formed by combining print data D14 with print client position information D12. Incidentally, data items other than these items may be contained in the print transmitting data D10.

Then, as shown in FIG. 6, the print client 20 transmits the print transmitting data D10 to the printer 30 (step S56). Specifically, it designates the network address of the printer 30 and sends out the print transmitting data D10 to the network 10. Incidentally, although the print transmitting data D10 is encrypted and transmitted to the printer 30 at the time of transmission in this embodiment, the print transmitting data D10 need not be necessarily encrypted.

Subsequently, the print client 20 judges whether a judgment result indicating print permission or print refusal has been received from the printer 30 (step S58). When the judgment result has not been received (step S58: No), the print client 20 stands by while repeating the process in step S58.

When the judgment result has been received from the printer 30 (step S58: Yes), whether the received judgment result indicates print permission is judged (step S60). When the judgment result indicates print permission (step S60: Yes), the user is notified that print permission is given and a print operation is executed by the printer 30 (step S62).

On the other hand, when the judgment result does not indicate print permission (step S60: No), that is, when the judgment result indicates print refusal, the print client 20 notifies the user that print refusal is given by the printer 30 since the print client 20 is not within a predetermined distance range relative to the printer 30 (step S64).

The print request process according to this embodiment is completed by the above step S62 or step S64.

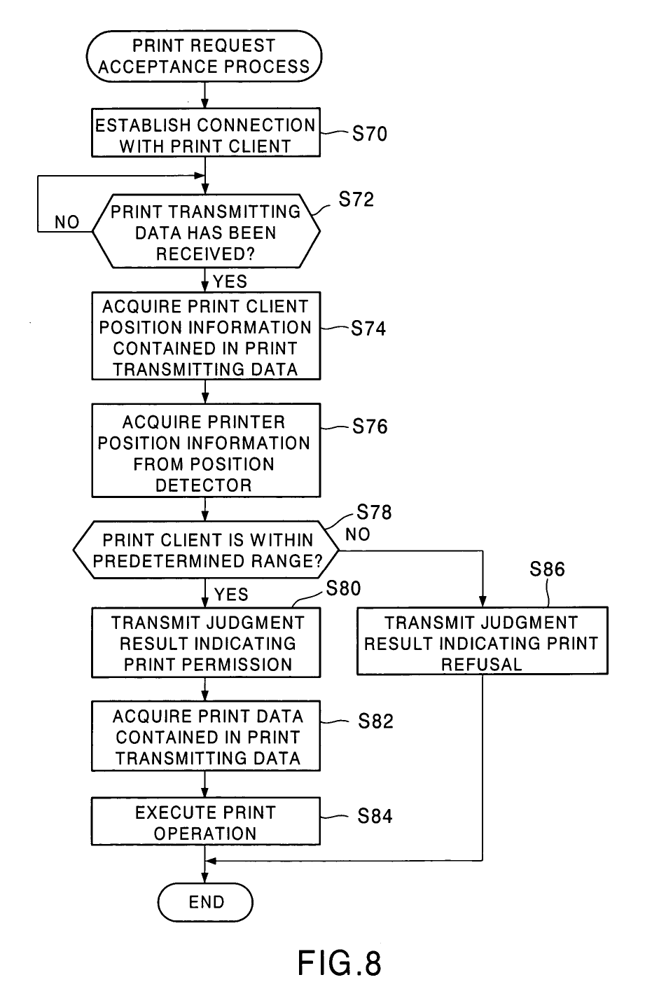

Next, a print request acceptance process executed by the printer 30 corresponding to the print request process will be explained based on FIG. 8. FIG. 8 is a flowchart explaining the print request acceptance process executed by the printer 30. This print request acceptance process is realized by making the CPU 64 read and execute a print request acceptance program stored in the ROM 44 of the printer 30. Also here, similarly to the above, assuming the case where the print client 20 makes a print request to the printer 30, the following explanation is given.

As shown in FIG. 8, first, the printer 30 establishes a connection with the print client 20 (step S70). This corresponds to the aforementioned step S50 on the print client 20 side. Namely, the print client 20 and the printer 30 are connected by SSL communication which ensures secrecy.

Thereafter, the printer 30 judges whether the print transmitting data D10 has been received from the print client 20 (step S72). When the print transmitting data D10 has not been received (step S72: No), the printer 30 stands by while repeating the process in step S72.

On the other hand, when the print transmitting data D10 has been received (step S72: Yes), the printer 30 acquires the print client position information D12 from the print transmitting data D10 (step S74). Specifically, the printer 30 decrypts the encrypted print transmitting data D10 and acquires the print client position information D12 from the decrypted print transmitting data D10.

Thereafter, the printer 30 acquires printer position information (step S76). Specifically, it acquires the latitude, longitude, and altitude of the position where the printer 30 is installed at this point in time from the position detector 54. Namely, the printer 30 acquires the absolute position of the printer 30 as the printer position information.

Then, the printer 30 judges whether the print client 20 is located within a predetermined range relative to the printer 30 (step S78). Namely, the relative distance between the print client 20 and the printer 30 is calculated based on the print client position information and the printer position information, and whether the calculated distance is not more than a predetermined value is judged. A calculation method therefor is the same as that in the aforementioned first embodiment.

When the print client 20 is located within the predetermined range (step S78: Yes), the printer 30 transmits a judgment result indicating print permission to the print client 20 (step S80). Specifically, it designates the network address of the print client 20 and sends out the judgment result indicating print permission to the network 10. Subsequently, the printer 30 acquires the print data D14 from the print transmitting data D10 (step S82). Specifically, it acquires the print data D14 from the print transmitting data D10 decrypted in step S74.

Thereafter, the printer 30 executes a print operation based on the acquired print data D14 (step S84). Specifically, it performs a language interpretation of the print data D14 and generates print request data fitting the print engine 52. Then, by transmitting this print request data to the print engine 52, print sheets and so on are printed by the print engine 52.

Contrary to this, when it is judged in the aforementioned step 78 that the print client 20 is not located within the predetermined range (step S78: No), the printer 30 transmits a judgment result indicating print refusal to the print client 20 (step S86). Specifically, it designates the network address of the print client 20 and sends out the judgment result indicating print refusal to the network 10.

The print request acceptance process according to this embodiment is completed by the above step S84 or step S86.

As described above, according to the print system of this embodiment, the printer 30 executes a print operation of the print transmitting data D10 transmitted from print clients which are located within a predetermined distance range relative to the printer 30, but does not execute a print operation of the print transmitting data D10 transmitted from print clients which are not located within the predetermined distance range. Hence, the installation range of print clients for which the printer 30 executes a print operation can be restricted.

Moreover, according to the print system of this embodiment, when a print client user transmits the print transmitting data D10 by mistake to the printer 30 installed in a distant place, which the user does not intend to use, the printer 30 does not execute a print operation based on this print transmitting data D10. Hence, the execution of a print operation by the printer 30 installed in the distant place, which the user does not intend to use, can be avoided.

It should be mentioned that the present invention is not limited to the aforementioned embodiments, and various changes may be made therein. For example, the print client position information D12 and the print data D14 are transmitted as one piece of data from each of the print clients 20 and 22 to the printer 30 in the aforementioned second embodiment, but they need not be necessarily one piece of data. Namely, in the second embodiment, the print client position information D12 has only to be transmitted to the printer 30 in association with the print data D14. At the time of this transmission, the print data D14 and the print client position information D12 may be transmitted with a temporal interval between them, and either of them may be transmitted earlier to the printer 30. In other words, in the second embodiment, regardless of whether print requests from the print clients 20 and 22 are permitted by the printer 30, the print clients 20 and 22 are required only to transmit the print data D14 and the print client position information D12 to the printer 30.

Moreover, in the aforementioned embodiments, as an example in which a print request is restricted, the case where the print request is not accepted is explained, but the print request restriction is not limited to the above case. For example, it is also possible that in the case of a print request from within a company (within a predetermined range), there is no restriction on the number of print sheets, and that in the case of a print request from outside the company (outside the predetermined range), the number of print sheets is restricted to 10. Alternatively, it is also possible that in the case of a print request from within a workplace (within a predetermined range), both color print and black-and-white print are possible, and that in the case of a print request from outside the workplace (outside the predetermined range), print is limited to only black-and-white print. Further, it is also possible that in the case of the print request from outside the predetermined range, only a print request of print data transmitted from an IP address which is previously registered with the printer is accepted.

Furthermore, it is possible that in the case of a print request from within a store (hot spot) which provides an Internet-access service by means of a wireless LAN, the print request is accepted without special restriction, and that in the case of a print request from outside such a store, the print request is restricted. For example, it is possible that in the case of the print request from outside the store, the print request transmitted by wireless LAN connection is not accepted, and that the print request transmitted by wired connection by inserting an IC card into a slot of the print client is accepted.

In addition, the present invention is explained with the print client as an example of a data transmitting device which transmits data to request some kind of process and the printer as an example of a data receiving device which receives and processes the data in the aforementioned embodiments, but a combination of the data transmitting device and the data receiving device in a data transmitting and receiving system is not limited to that in the aforementioned embodiments. For example, in the data transmitting and receiving system, the data transmitting device may be a digital camera for taking images and the data receiving device may be a data server which stores data on the images taken by the digital camera. In this case, when a distance between the digital camera and the data server is within a predetermined range, data transmission from the digital camera to the data server is permitted or data received from the digital camera by the data server is stored in the data server.

Moreover, in the data transmitting and receiving system, the data transmitting device may be a personal computer and the data receiving device may be a projector which projects image data transmitted from the personal computer. In this case, when a distance between the personal computer and the projector is within a predetermined range, data transmission from the personal computer to the projector is permitted, or an image based on the data received from the personal computer by the projector is projected by the projector.

Further, in the data transmitting and receiving system, the data transmitting device may be a content server for music or the like and the data receiving device may be a playback device for content data such as music transmitted from the content server. In this case, when a distance between the content server and the playback device is within a predetermined range, data transmission from the content server to the playback device is permitted, or music or the like based on the data received from the content server by the playback device is played back by the playback device.

Furthermore, the aforementioned embodiments are explained with the case where a print medium of the printer 30 is a print sheet as an example, but the print medium is not limited to this, and the present invention can be applied to other print media such as an OHP sheet and the like.

Besides, as for each process explained in the aforementioned embodiments, it is possible to record a program to execute each process on a record medium such as a flexible disk, a CD-ROM (Compact Disc-Read Only Memory), a ROM, a memory card, or the like and distribute this program in the form of the record medium. In this case, the aforementioned embodiments can be realized by making the print client 20 or 22 and/or the printer 30 read the record medium on which this program is recorded and execute this program.

The print client 20 or 22 and/or the printer 30 sometimes has other programs such as an operating system, other application programs, and the like. In this case, in order to use these other programs in the print client 20 or 22 and/or the printer 30, a command, which calls a program to realize a process equal to that in the aforesaid embodiments out of programs in the print client 20 or 22 and/or the printer 30, may be recorded on the record medium.

Further, such a program can be distributed not in the form of the record medium but in the form of a carrier wave via a network. The program transmitted in the form of the carrier wave over the network is incorporated in the client 20 or 22 and/or the printer 30, and the aforesaid embodiments can be realized by executing this program.

Furthermore, when being recorded on the record medium or transmitted as the carrier wave over the network, the program is sometimes encrypted or compressed. In this case, the print client 20 or 22 and/or the printer 30 which has read the program from the record medium or the carrier wave needs to execute the program after decrypting or expanding it.

What is claimed is:

1. A printer connected to a print client via a network, comprising:
a print client position information acquisition which acquires print client position information indicating a position where the print client is installed;
a printer position information acquisition which acquires printer position information indicating a position where the printer is installed;
a first judgment section which judges whether a distance between the print client and the printer is within a predetermined range based on the print client position information and the printer position information; and
a second judgment section which accepts a print request from the print client when the first judgment section judges that the distance between the print client and the printer is within the predetermined range and restricts the print request from the print client when the first judgment section judges that the distance between the print client and the printer is not within the predetermined range.

2. The printer according to claim 1, wherein the second judgment section does not accept the print request from the print client when the first judgment section judges that the distance between the print client and the printer is not within the predetermined range.

3. The printer according to claim 2, wherein the print client position information acquisition acquires the print client position information on the print client before print data is received from the print client, and
the second judgment section permits the print client to transmit the print data when the first judgment section judges that the distance between the print client and the printer is within the predetermined range, and the second judgment section does not permit the print client to transmit the print data when the first judgment section judges that the distance between the print client and the printer is not within the predetermined range.

4. The printer according to claim 2, wherein the print client position information on the print client is transmitted in association with print data from the print client;
the print client position information acquisition acquires the print client position information transmitted in association with the print data; and
the second judgment section executes a print operation based on the print data transmitted in association with the print client position information when the first judgment section judges that the distance between the print client and the printer is within the predetermined range, and the second judgment section does not execute the print operation based on the print data transmitted in association with the print client position information when the first judgment section judges that the distance between the print client and the printer is not within the predetermined range.

5. The printer according to claim 4, wherein the print client position information is combined with the print data and transmitted from the print client as one piece of print transmitting data.

6. A print system including a printer and a print client connected to the printer via a network,
wherein the print client comprises a first print client position information acquisition which acquires print client position information indicating a position where the print client is installed, and
wherein the printer comprises:
a second print client position information acquisition which acquires the print client position information from the print client;
a printer position information acquisition which acquires printer position information indicating a position where the printer is installed;
a first judgment section which judges whether a distance between the print client and the printer is within a predetermined range based on the print client position information and the printer position information; and
a second judgment section which accepts a print request from the print client when the first judgment section judges that the distance between the print client and the printer is within the predetermined range and restricts the print request from the print client when the first judgment section judges that the distance between the print client and the printer is not within the predetermined range.

7. The print system according to claim 6, wherein the second judgment section does not accept the print request from the print client when the first judgment section judges that the distance between the print client and the printer is not within the predetermined range.

8. The print system according to claim 7, wherein the print client further comprises a first transmitter which transmits the print client position information acquired by the fist print client position information acquisition to the printer before print data is transmitted to the printer,
wherein the second print client position information acquisition acquires the print client position information by receiving the print client position information transmitted by the first transmitter, and
the second judgment section permits the print client to transmit the print data when the first judgment section judges that the distance between the print client and the printer is within the predetermined range, and the second judgment section does not permit the print client to transmit the print data when the first judgment section judges that the distance between the print client and the printer is not within the predetermined range.

9. The print system according to claim 8, wherein the print client further comprises a second transmitter which transmits the print data to the printer when the transmission of the print data is permitted by the printer, and does not transmit the print data to the printer when the transmission of the print data is not permitted by the printer.

10. The print system according to claim 7, wherein the print client further comprises a third transmitter which transmits the print client position information acquired by the fist print client position information acquisition in association with print data to the printer,
wherein the second print client position information acquisition acquires the print client position information transmitted in association with the print data, and
the second judgment section executes a print operation based on the print data transmitted in association with the print client position information when the first judgment section judges that the distance between the print client and the printer is within the predetermined range, and the second judgment section does not execute the print operation based on the print data transmitted in association with the print client position information when the first judgment section judges that the distance between the print client and the printer is not within the predetermined range.

11. The print system according to claim 10, wherein the third transmitter combines the print client position information with the print data and transmits the print client position information and the print data as one piece of print transmitting data.

12. A method of controlling a printer connected to a print client via a network, comprising the steps of:
acquiring print client position information indicating a position where the print client is installed;
acquiring printer position information indicating a position where the printer is installed;
judging whether a distance between the print client and the printer is within a predetermined range based on the print client position information and the printer position information;
accepting a print request from the print client when it is judged that the distance between the print client and the printer is within the predetermined range; and
restricting the print request from the print client when it is judged that the distance between the print client and the printer is not within the predetermined range.

13. The method of controlling the printer according to claim 12, wherein, in the step of restricting the print request from the print client, the print request from the print client is not accepted.

14. The method of controlling the printer according to claim 13, wherein, in the step of acquiring the print client position information, the print client position information on the print client is acquired before print data is received from the print client,
wherein, in the step of accepting the print request from the print client, a judgment result indicating that the print client is permitted to transmit the print data is transmitted, and
wherein, in the step of not accepting the print request from the print client, a judgment result indicating that the print client is not permitted to transmit the print data is transmitted.

15. The method of controlling the printer according to claim 13, wherein, in the step of acquiring the print client position information, the print client position information transmitted in association with print data is received,
wherein, in the step of accepting the print request from the print client, a print operation based on the print data transmitted in association with the print client position information is executed, and
wherein, in the step of not accepting the print request from the print client, the print operation based on the print data transmitted in association with the print client position information is not executed.

16. The method of controlling the printer according to claim 15, wherein the step of acquiring the print client position information comprises the steps of:
receiving print transmitting data in which the print data and the print client position information are combined; and
extracting the print client position information from the print transmitting data.

17. A method of controlling a print system including a printer and a print client connected to the printer via a network, comprising the steps of:
acquiring print client position information indicating a position where the print client is installed in the print client;
transmitting the print client position information from the print client to the printer;
acquiring the print client position information transmitted from the print client in the printer;
acquiring printer position information indicating a position where the printer is installed in the printer;
judging whether a distance between the print client and the printer is within a predetermined range based on the print client position information and the printer position information;
accepting a print request from the print client when it is judged that the distance between the print client and the printer is within the predetermined range, and
restricting the print request from the print client when it is judged that the distance between the print client and the printer is not within the predetermined range.

18. The method of controlling the print system according to claim 17, wherein in the step of restricting the print request from the print client, the print request from the print client is not accepted when it is judged that the distance between the print client and the printer is not within the predetermined range.

19. The method of controlling the print system according to claim 18, wherein in the step of transmitting the print client position information, the print client position information is transmitted to the printer before print data is transmitted to the printer,
wherein in the step of accepting the print request from the print client, the print client is permitted to transmit the print data, and
wherein in the step of not accepting the print request from the print client, the print client is not permitted to transmit the print data.

20. The method of controlling the print system according to claim 19, further comprising the steps of:
judging whether the transmission of the print data is permitted by the printer in the print client;
transmitting the print data to the printer when it is judged that the transmission of the print data is permitted; and
canceling the transmission of the print data when it is judged that the transmission of the print data is not permitted.

21. The method of controlling the print system according to claim 18, wherein in the step of acquiring the print client position information, the print client position information transmitted in association with print data is acquired,
wherein in the step of accepting the print request from the print client, a print operation based on the print data transmitted in association with the print client position information is executed, and
wherein in the step of not accepting the print request from the print client, the print operation based on the print data transmitted in association with the print client position information is not executed.

22. The method of controlling the print system according to claim 21, wherein in the step of transmitting the print client position information from the print client to the printer, the print client position information is combined with the print data and transmitted as one piece of print transmitting data to the printer.

23. A print client connected to a printer via a network, comprising:
a print client position information acquisition which acquires print client position information indicating a position where the print client is installed;
a print client position information transmitter which transmits the print client position information acquired by the print client position information acquisition to the printer;
a judgment result receiver which receives a judgment result from the printer, as to whether the printer gives a print permission based on the print client position information; and
a print data transmitter which transmits print data to the printer when the judgment result received by the judgment result receiver indicates that the printer gives the print permission and does not transmit the print data to the printer when the judgment result indicates that the printer does not give the print permission.

24. A print client connected to a printer via a network, comprising:
a print client position information acquisition which acquires print client position information indicating a position where the print client is installed;
a print transmitting data generator which generates print transmitting data by incorporating the print client position information acquired by the print client position information acquisition into print data; and
a print data transmitter which transmits the print transmitting data generated by the print transmitting data generator to the printer.

25. A method of controlling a print client connected to a printer via a network, comprising the steps of:
acquiring print client position information indicating a position where the print client is installed;
transmitting the acquired print client position information to the printer;
receiving a judgment result from the printer, as to whether the printer gives a print permission based on the print client position information; and
transmitting print data to the printer when the received judgment result indicates that the printer gives the print permission and not transmitting the print data to the printer when the judgment result indicates that the printer does not give the print permission.

26. A method of controlling a print client connected to a printer via a network, comprising the steps of:
acquiring print client position information indicating a position where the print client is installed;
generating print transmitting data by incorporating the acquired print client position information into print data; and
transmitting the generated print transmitting data to the printer.

27. A data receiving device connected to a data transmitting device via a network, comprising:
a data transmitting device position information acquisition which acquires data transmitting device position information indicating a position where the data transmitting device is installed;
a data receiving device position information acquisition which acquires data receiving device position information indicating a position where the data receiving device is installed;
a first judgment section which judges whether a distance between the data transmitting device and the data receiving device is within a predetermined range based on the data transmitting device position information and the data receiving device position information; and
a second judgment section which accepts a process request from the data transmitting device when the first judgment section judges that the distance between the data transmitting device ad the data receiving device is within the predetermined range and restricts the process request from the data transmitting device when the first judgment section judges that the distance between the data transmitting device and the data receiving device is not within the predetermined range.

28. A data transmitting and receiving system including a data receiving device and a data transmitting device connected to the data receiving device via a network,
wherein the data transmitting device comprises a first data transmitting device position information acquisition which acquires data transmitting device position information indicating a position where the data transmitting device is installed, and
wherein the data receiving device comprises:
a second data transmitting device position information acquisition which acquires the data transmitting device position information from the data transmitting device;
a data receiving device position information acquisition which acquires data receiving device position information indicating a position where the data receiving device is installed;
a first judgment section which judges whether a distance between the data transmitting device and the data receiving device is within a predetermined range based on the data transmitting device position information and the data receiving device position information; and
a second judgment section which accepts a process request from the data transmitting device when the first judgment section judges that the distance between the data transmitting device and the data receiving device is within the predetermined range and restricts the process request from the data transmitting device when the first judgment section judges that the distance between the data transmitting device and the data receiving device is not within the predetermined range.

29. A data transmitting device connected to a data receiving device via a network, comprising:
a data transmitting device position information acquisition which acquires data transmitting device position information indicating a position where the data transmitting device is installed;
a data transmitting device position information transmitter which transmits the data transmitting device position information acquired by the data transmitting device position information acquisition to the data receiving device;
a judgment result receiver which receives a judgment result, as to whether the data receiving device gives a process permission based on the data transmitting device position information, from the data receiving device;
a process data transmitter which transmits process data to the data receiving device when the judgment result received by the judgment result receiver indicates that the data receiving device gives the process permission and does not transmit the process data to the data receiving device when the judgment result indicates that the data receiving device does not give the process permission.

30. A data transmitting device connected to a data receiving device via a network, comprising:
a data transmitting device position information acquisition which acquires data transmitting device position information indicating a position where the data transmitting device is installed;
a transmitting process data generator which generates transmitting process data by incorporating the data transmitting device position information acquired by the data transmitting device position information acquisition into process data; and
a process data transmitter which transmits the transmitting process data generated by the transmitting process data generator to the data receiving device.

31. A method of controlling a data receiving device connected to a data transmitting device via a network, comprising the steps of:
acquiring data transmitting device position information indicating a position where the data transmitting device is installed;
acquiring data receiving device position information indicating a position where the data receiving device is installed;
judging whether a distance between the data transmitting device and the data receiving device is within a predetermined range based on the data transmitting device position information and the data receiving device position information;
accepting a process request from the data transmitting device when it is judged that the distance between the data transmitting device and the data receiving device is within the predetermined range; and
restricting the process request from the data transmitting device when it is judged that the distance between the data transmitting device and the data receiving device is not within the predetermined range.

32. A method of controlling a data transmitting and receiving system including a data receiving device and a data transmitting device connected to the data receiving device via a network, comprising the steps of:
acquiring data transmitting device position information indicating a position where the data transmitting device is installed in the data transmitting device;
acquiring the data transmitting device position information from the data transmitting device in the data receiving device;
acquiring data receiving device position information indicating a position where the data receiving device is installed;
judging whether a distance between the data transmitting device and the data receiving device is within a predetermined range based on the data transmitting device position information and the data receiving device position information;
accepting a process request from the data transmitting device when it is judged that the distance between the data transmitting device and the data receiving device is within the predetermined range, and
restricting the process request from the data transmitting device when it is judged that the distance between the data transmitting device and the data receiving device is not within the predetermined range.

33. A method of controlling a data transmitting device connected to a data receiving device via a network, comprising the steps of:
acquiring data transmitting device position information indicating a position where the data transmitting device is installed;
transmitting the acquired data transmitting device position information to the data receiving device;
receiving a judgment result, as to whether the data receiving device gives a process permission based on the data transmitting device position information, from the data receiving device;
transmitting process data to the data receiving device when the received judgment result indicates that the data receiving device gives the process permission; and
canceling the transmission of the process data to the data receiving device when the judgment result indicates that the data receiving device does not give the process permission.

34. A method of controlling a data transmitting device connected to a data receiving device via a network, comprising the steps of:
acquiring data transmitting device position information indicating a position where the data transmitting device is installed;
generating transmitting process data by incorporating the acquired data transmitting device position information into process data; and
transmitting the generated transmitting process data to the data receiving device.
